(19) United States
(12) Patent Application Publication
(10) Pub. No.: US 2025/0111222 A1
(43) Pub. Date: Apr. 3, 2025

(54) DYNAMIC PATH SELECTION FOR PROCESSING THROUGH A MULTI-LAYER NEURAL NETWORK

(71) Applicant: NVIDIA Corporation, Santa Clara, CA (US)

(72) Inventors: Zekun Hao, Santa Clara, CA (US); Ming-Yu Liu, San Jose, CA (US); Arun Mallya, Mountain View, CA (US)

(21) Appl. No.: 18/375,377

(22) Filed: Sep. 29, 2023

(51) Int. Cl. G06N 3/08; G06N 3/04

(52) U.S. Cl. CPC G06N 3/08; G06N 3/04

(57) ABSTRACT

Performance of a neural network is usually a function of the capacity, or complexity, of the neural network, including the depth of the neural network (i.e. the number of layers in the neural network) and/or the width of the neural network (i.e. the number of hidden channels). However, improving performance of a neural network by simply increasing its capacity has drawbacks, the most notable being the increased computational cost of a higher-capacity neural network. Since modern neural networks are configured such that the same neural network is evaluated regardless of the input, a higher capacity neural network means a higher computational cost incurred per input processed. The present disclosure provides for a multi-layer neural network that allows for dynamic path selection through the neural network when processing an input, which in turn can allow for increased neural network capacity without incurring the typical increased computation cost associated therewith.

### TECHNICAL FIELD

The present disclosure relates to configurations for multi-layer neural networks.

### BACKGROUND

How well a neural network performs is oftentimes a function of the capacity, or complexity, of the neural network. For example, a neural network with too little capacity will be less likely to be able to effectively learn from a training dataset, and thus will underfit. Because capacity is conventionally defined by the depth of the neural network (i.e. the number of layers in the neural network) and/or the width of the neural network (i.e. the number of hidden channels), increasing the capacity in turn requires more layers and/or more hidden channels.

However, improving performance of a neural network by increasing its capacity has drawbacks. The most notable drawback is the increased computational cost of a higher-capacity neural network. Since modern neural networks are configured such that the same neural network is evaluated regardless of the input, a higher capacity neural network means a higher computational cost incurred per input processed.

There is a need for addressing these issues and/or other issues associated with the prior art. For example, there is a need to provide a multi-layer neural network that allows for dynamic path selection through the neural network when processing an input.

### SUMMARY

A method, computer readable medium, and system are disclosed to provide for dynamic path selection for processing through a multi-layer neural network. An input is processed, through a plurality of layers of a neural network, to predict a data value for the input, where at least one of the plurality of layers of the neural network is partitioned, and where a partition of at least one partitioned layer is dynamically selected for the processing according to the input. The data value is output.

### BRIEF DESCRIPTION OF THE DRAWINGS

FIG. 1 illustrates a flowchart of a method for dynamic path selection for processing through a multi-layer neural network, in accordance with an embodiment.

FIG. 2 illustrates a block diagram of a neural network having partitioned layers, in accordance with an embodiment.

FIG. 3 illustrates a block diagram of a neural network having partitioned layers through which a 1 dimensional (1D) input is processed, in accordance with an embodiment.

FIG. 4 illustrates various examples of different weight tiling patterns, in accordance with various embodiments.

FIG. 5 illustrates a block diagram of a neural network having partitioned layers through which a 2 dimensional (2D) input is processed, in accordance with an embodiment.

FIG. 6 illustrates another block diagram of a neural network having partitioned layers through which a 2D input is processed, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

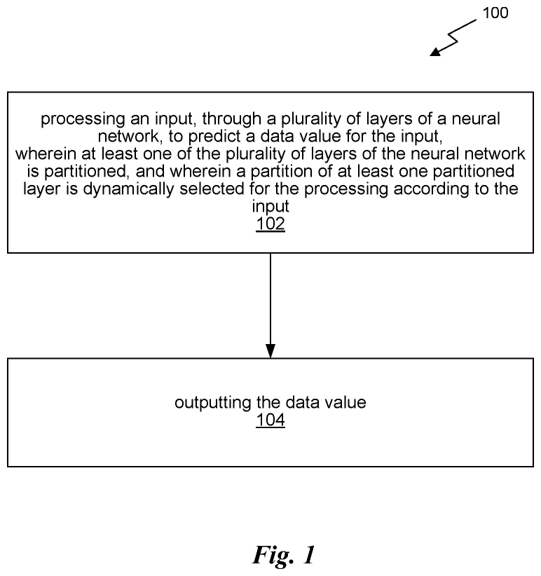

FIG. 1 illustrates a flowchart of a method 100 for dynamic path selection for processing through a multi-layer neural network, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, an input is processed, through a plurality of layers of a neural network, to predict a data value for the input. The input refers to any type of data that the neural network is configured to process to predict an output. In an embodiment, the input may be a coordinate position (e.g. x,y coordinate position), such as where the neural network is a coordinate-based neural network that predicts the data value at the location specified by the input coordinate position. In an embodiment, the neural network may be used to provide an implicit neural representation (INR) of data.

In addition to the coordinate position, the input may also include at least one additional parameter value, which controls the prediction made by the neural network. In an embodiment, the input may be processed along with a conditional input, through the plurality of layers of the neural network, to predict the data value for the input. For example, the conditional input may be a vector derived from at least one of a text or an image.

In one exemplary embodiment where the neural network produces 2D images, the input may be a coordinate position (x and y pixel coordinates). To control the day-night appearance of the image, the network can also be provided with another input (parameter) of time-in-a-day (e.g. denoted as t). Now the network has 3 inputs, x, y and t. After the network is trained using appropriate data, when we vary t from 0 to 24, the result image will go from night to day to night. Some other examples of additional input parameters include the height of the sun, angles of the joints of a person, etc.

As mentioned, the neural network includes a plurality of layers. For example, the neural network may be a multi-layer perceptron (MLP), which may consist of fully connected layers. One or more of the layers are configured to perform some computation on the input and/or on an output of a previous layer of the neural network.

In the context of the present operation, at least one of the layers of the neural network is partitioned. Partitioning a layer of the neural network refers to apportioning parameters of the layer into different partitions. Each partitioned layer of the neural network may therefore include a plurality of partitions. The partitions may each be a 1D, 2D, etc. matrix of parameters.

For example, in an embodiment, each partitioned layer of the neural network may include at least two partitions with a different set of weights. In an embodiment, each set of weights may be arranged as a matrix. In an embodiment, each partitioned layer of the neural network may have a different number of weights per partition than other partitioned layers of the neural network.

In an embodiment, each partitioned layer of the neural network may have a random pattern of partitions. In another embodiment, for each partitioned layer of the neural network, the partitions may be repeated at a defined frequency. In an embodiment, the frequency may increase for each subsequent partitioned layer of the neural network.

In an embodiment, a layout of the partitions that are repeated within the partitioned layer may be predefined. For example, the layout may include a random order. As another example, the layout may be predefined for a task to be performed using the neural network, such as an image generation task, a novel-view synthesis task, an image fitting task, a video fitting task, etc. As yet another example, the layout may include a smooth interpolation across the partitions within the partitioned layer.

Also in the context of the present operation, a partition of at least one partitioned layer is dynamically selected for the processing according to the input. In other words, for at least one partitioned layer of the neural network, one of the partitions of the layer is selected for the processing, and which partition is selected is based on the input itself. For example, for at least one partitioned layer of the neural network, each partition may be configured to handle a corresponding range of inputs. In this example, for at least one partitioned layer of the neural network, the particular one of the partitions of that layer that is configured to handle the given input may be selected for the processing.

In an embodiment, for at least one partitioned layer of the neural network, only the selected partition may be active for the processing. For example, remaining (non-selected) partitions of the partitioned layer may not be active for the processing. Accordingly, while a capacity of the neural network may be increased by increasing a width of partitioned layers of the neural network, the computation cost incurred may be limited to the single partition selected to perform the processing. It should be noted that the dynamic selection may be made for any number of partitioned layers of the neural network. In an example, the dynamic selection may be made for each partitioned layer of the neural network, whereas in other examples one or more of the partitioned layers may be skipped during processing through the neural network and/or one or more of the partitioned layers may have their partition selected in a non-dynamic (i.e. static) manner.

In operation 104, the data value is output. The data value may be output to a downstream task, which may take the data value as input to generate some output. As mentioned above, the downstream task may include an image generation task, a novel-view synthesis task, an image fitting task, a video fitting task, etc.

Just by way of example, in an embodiment, the input may be a pixel position. The neural network may process the pixel position, through its layers as described above, to predict a data value which is a color at the pixel position. This method 100 may then be repeated for multiple different pixel positions, to obtain color values for the different pixel positions. Of course, repeating the method 100 in this manner depends on what specific input is required by the downstream task.

Further embodiments will now be provided in the description of the subsequent figures. It should be noted that the embodiments disclosed herein with reference to the method 100 of FIG. 1 may apply to and/or be used in combination with any of the embodiments of the remaining figures below.

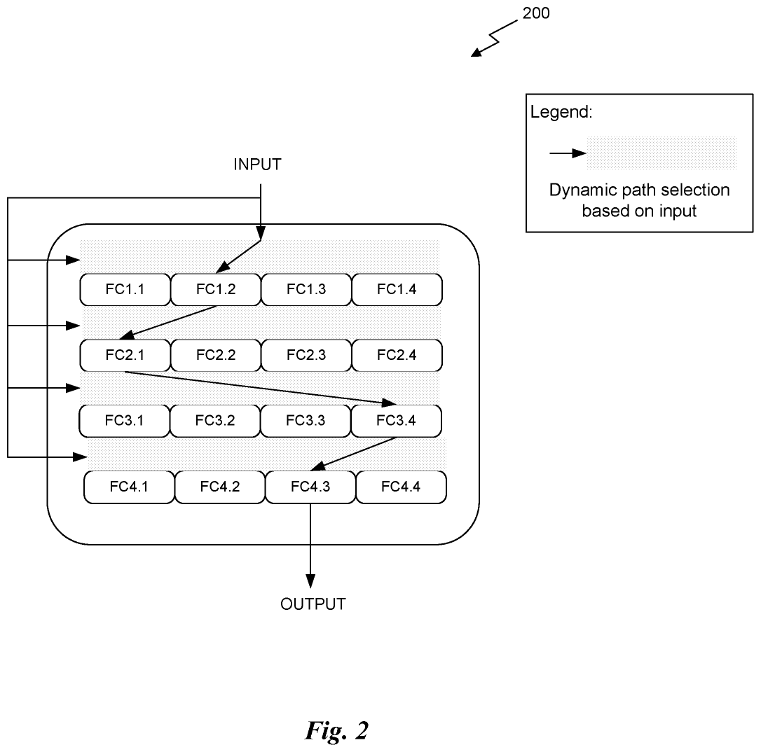

FIG. 2 illustrates a block diagram of a neural network 200 having partitioned layers, in accordance with an embodiment. The neural network 200 may be an example of the neural network disclosed in the method 100 of FIG. 1.

As shown, the neural network 200 has multiple partitions per (e.g. fully connected) layer. The first layer includes partitions FC1.1 through FC1.4. The second layer includes partitions FC2.1 through FC2.4. The third layer includes partitions FC3.1 through FC3.4. The fourth layer includes partitions FC4.1 through FC4.4. While the neural network 200 is illustrated as having four layers, it should be noted that the neural network 200 is not necessarily limited to this embodiment. Other embodiments are contemplated in which the neural network 200 has two layers, or number of layers greater than two.

Furthermore, while each layer of the neural network 200 is illustrated as having four partitions, it should be noted that the neural network 200 is not necessarily limited to this embodiment. For example, only one layer of the neural network 200 may be partitioned, or more than one layer of the neural network 200 may be partitioned, or all layers of the neural network 200 may be partitioned. In addition, each partitioned layer is not necessarily limited to having four partitions, but in other embodiments may have two or more partitions as desired.

When an input is processed through the neural network 200, a partition of each partitioned layer is dynamically selected for the processing. In particular, for each partitioned layer of the neural network 200, the input is used as a basis to select one of the partitions for the processing. As shown in FIG. 2, the input is used for the dynamic path selection process preceding each partitioned layer FC1 through FC4.

As mentioned, the dynamic path selection process, and in particular the partition selection made per partitioned layer, is based on the input. In an embodiment, a hashing function may be configured to map inputs to partitions. In an embodiment, the hashing function may map the inputs to partition indexes. In an embodiment, the hashing function may map the inputs to integer values of the partition indexes. In an embodiment, a different hashing function may be configured for each partitioned layer.

To this end, for each partitioned layer of the neural network, only the selected partition may be active for the processing. For example, remaining (non-selected) partitions of the partitioned layer may not be active for the processing. As a result, while a capacity of the neural network may be increased by increasing a width of partitioned layers of the neural network, the computation cost incurred may be limited to the single partition selected to perform the processing. Furthermore, the partitioned configuration of the layers maintains a compact latent representation, and allows for a neural network that is highly parameter-efficient.

### Exemplary Implementation

A typical coordinate-based MLP can be described as a stack of layers, per Equation 1.

$$\hat{f} : p \to ( {g}^{k} ∘ ∅ ∘ {g}^{k - 1} ∘ … ∘ {g}^{1} ∘ γ ) ( p ) \qquad Equation l$$

p is the input coordinate at which the MLP is being evaluated, γ is an input mapping, such as the sine-cosine positional encoding, └ is a non-linear activation function, and gⁱ: x→Wⁱx+bⁱ is the i^{th} linear layer, which performs an affine transformation on the input x, parameterized by a weight matrix Wⁱ and a bias vector bⁱ. During training, Wⁱ and bⁱ are optimized via gradient descent to fit the MLP to the data.

In the present approach, instead of regarding each Wⁱ as a single learnable matrix, it is modeled as a function ψⁱ(·) of the input coordinate p. The resulting dynamic-weight linear layer has the form hⁱ: (x, p)→ψⁱ(p)x+bⁱ, where x are the inputs to the layer, and p are the location at which the MLP is being evaluated. By replacing the traditional linear layers gⁱ in the MLP with dynamic-weight layers hⁱ, we obtain an MLP with input-dependent weights, per Equation 2.

$$f : p \to ( {h}^{k} ( p ) ∘ ∅ ∘ {h}^{k - 1} ( p ) ∘ … ∘ ∅ ∘ {h}^{1} ( p ) ∘ γ ) ( p ) \qquad Equation 2$$

As the resulting position-dependent weight matrix has a much higher dimension compared to its input and output vectors and will be evaluated at a large number of query points, it is important for the weight generation functions ψⁱ (p) to be fast, inexpensive, and yet expressive. Accordingly, a simple, lightweight function is used, specifically a coordinate interpolation-based method. Multiple candidate values for the weight matrix are stored in a regular grid (tile) and interpolated in a cyclic manner based on the input coordinates.

Consider the case of a grid containing N matrices {W₀ⁱ, . . . , W_{N-1}ⁱ} where i is the layer depth, and N is a nonnegative integer. We are only interested in the case that N>1 as N=1 reduces to the original pointwise MLP formulation. Given a 1D coordinate p=(p), the input-dependent weight for layer i, Wⁱ, is computed per Equation 3.

$${W}^{i} = {ψ}^{i} ( p ) = {ψ}^{i} ( p ) = {\sum }_{j = 0}^{n - 1} {B}_{j , N} ( {α}^{i} p + {β}^{i} ) {W}_{j}^{i} \qquad Equation 3$$

αⁱ and βⁱ are hyperparameters that adjust the scale and translation of the grid for each layer and B_{j,N} is the blending function that computes the blending coefficient for the j-th candidate. The blending coefficient can take many different forms. For linear and nearest interpolations, they are defined per Equations 4 and 5.

$${B}_{j , N}^{linear} ( q ) = max ( 0 , 1 - \vert q + 1 - j ) mod N - 1 \vert ) \qquad Equation 4$$

$${B}_{j , N}^{n e a r e s t} ( q ) = \{ \begin{matrix}1 & \vert q \vert mod N = j \\ 0 & otherwise\end{matrix} \qquad Equation 5$$

Note that here mod denotes positive remainder operation:

$$a mod b = a - b \vert \frac{a}{b} \vert .$$

The above equations can easily be extended to multi-dimensional coordinate spaces.

For linear interpolation, regardless of the tile resolution, only 2 of the blending coefficients are non-zero for each coordinate in the 1D example. On the other hand, the nearest interpolation scheme only has a single non-zero coefficient for each coordinate. This sparsity allows a fast and efficient implementation of performing the dynamic-weight linear layer computation for batched inputs: for each candidate weight matrix, Wⱼⁱ, where only input vectors that have B_{j,N}>0 are gathered at a time, matrix multiplication and scaling is performed, and finally the results are scattered to the output matrix.

In an embodiment, different layers of the MLP may have different spatial frequencies on the grid. This can be achieved by using a different set of αⁱ and βⁱ per layer. Using different frequencies at different layers gives an inductive bias to the MLP to capture different repetition patterns. It also serves as a form of regularization that encourages the learning of smooth mapping via weight sharing at different locations. This is particularly useful in reducing artifacts for novel view synthesis tasks.

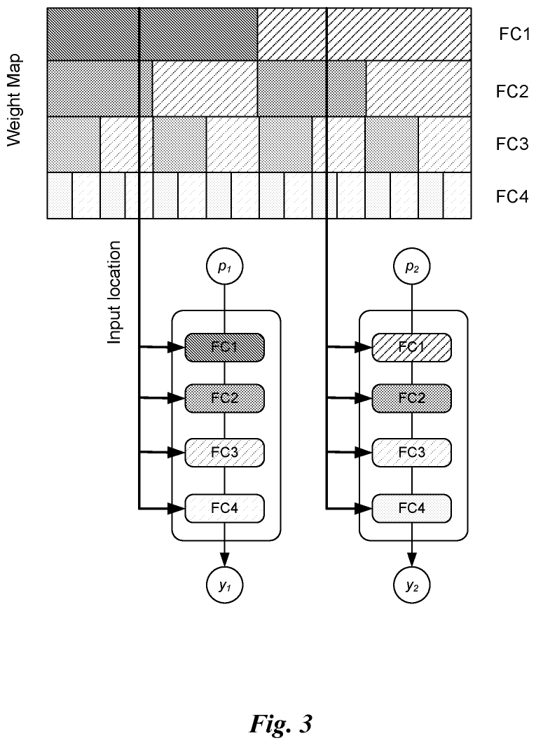

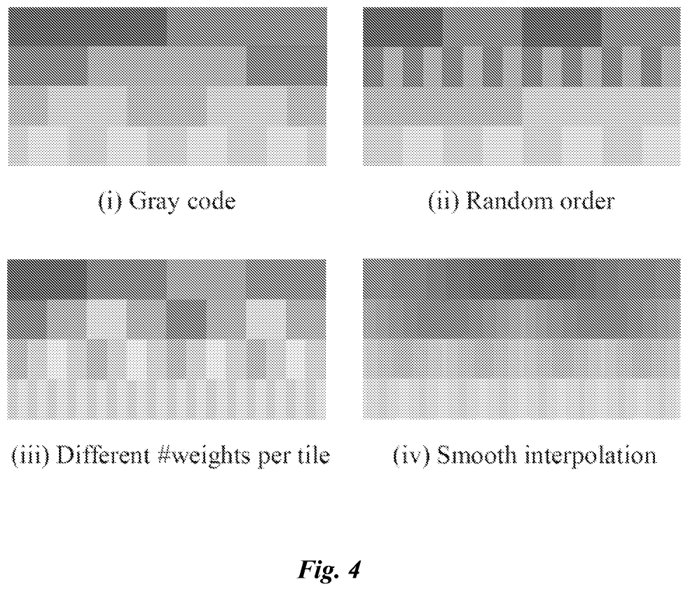

A non-exhaustive list of potential grid arrangements-a grid arrangement corresponds to a set of {(αᵢ,βⁱ)} are disclosed below with reference to FIG. 4. It is even possible to use a randomized tiling pattern by transforming the grid with a random affine transformation, while still seeing a significant performance gain compared to a regular MLP. The grids can be arranged in a progressively growing fashion, for example, with the first grid (corresponding to the first MLP layer) covering the full input space without repetition, and progressively subdividing the grids using additional layers. This is shown in FIG. 3. This arrangement partitions the input space into uniform-sized grids, with each one having a unique combination of weight matrices.

FIG. 3 illustrates a block diagram of a neural network 300 having partitioned layers through which a 1D input is processed, in accordance with an embodiment. The neural network 300 may be an example of the neural network 200 disclosed in FIG. 2.

In the present embodiment, the neural network 300 is a position-dependent MLP that is configured to take a 1D input, where y=f(p, θ(p)) (note: activation functions are omitted for brevity). Each fully connected layer FC1 through FC4 is partitioned with two candidate weight matrices (marked in the weight map as solid and stripes, respectively, with shade corresponding to layer depth). As shown, the weight matrices are arranged in a periodical (per layer) and hierarchical (through layers) manner. According to the input location, one of the weight copies is selected for each layer.

FIG. 4 illustrates various examples of different weight tiling patterns, in accordance with various embodiments. The weight tiling patterns are examples of the weight map that may be used by a neural network that processes 1D input, such as the neural network 300 of FIG. 3. The weight map, or weight layout, defines the mapping between the input to the neural network and the weights of each layer of the neural network. It should be noted that the neural network may support a large variety of layouts. In an embodiment, the layout used by a particular neural network can be tailored to the task supported by the neural network.

As shown in example (i), the weight tiling pattern has a specific alignment. In other embodiments, the weight tiling pattern can have varying orders of granularity as illustrated in example (ii) and/or varying length of the repetend as illustrated in example (iii). In a further embodiment, the weight tiling pattern can be generalized to a smooth interpolation across the weight matrices as illustrated in example (iv). Thus, each layer at a different level, or scale, has a number of experts with their own weight matrices, specializing at different regions of the input space.

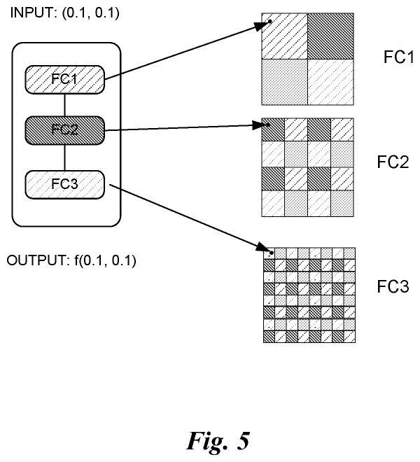

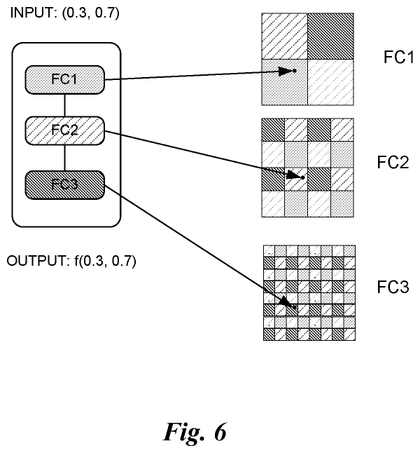

FIGS. 5-6 illustrate a block diagram of a neural network having partitioned layers through which a given 2 dimensional (2D) input is processed, in accordance with an embodiment. The neural network may be an example of the neural network disclosed in the method 100 of FIG. 1. Of course, however the neural network may be implemented in the context of any of the other Figures disclosed herein.

In the examples shown, each layer of the neural network includes a different weight map configuration. In FIG. 5, given a particular input coordinate (0.1, 0.1), a partition of each neural network layer is selected accordingly for processing of that input coordinate through the neural network. In particular, the partition selected per layer is that which is mapped to the input coordinate (0.1, 0.1). In FIG. 6, given a particular input coordinate (0.3, 0.7), a partition of each neural network layer is selected accordingly for processing of that input coordinate through the neural network. In particular, the partition selected per layer is that which is mapped to the input coordinate (0.3, 0.7).

The output of the neural network is therefore a function of the input coordinate, per the processing of such input through the layers. The output of the neural network is also a function of the input coordinate by virtue of the use of the input coordinate to select which partition is selected, per layer, for use in the processing of the input through the neural network.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

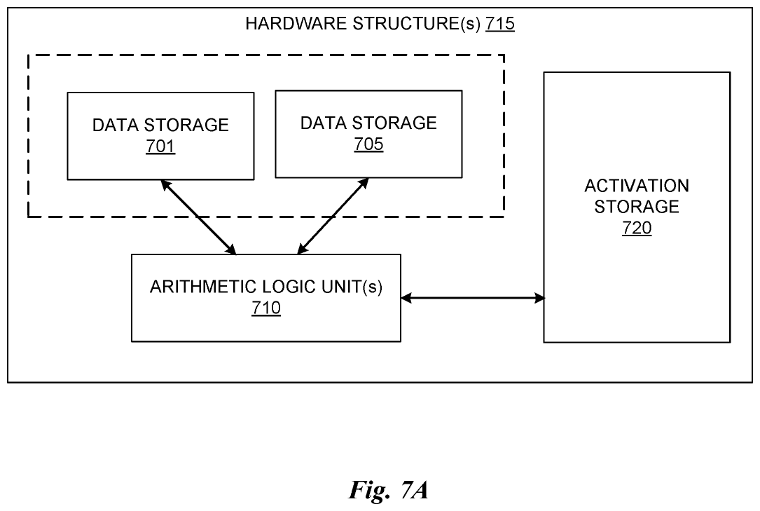

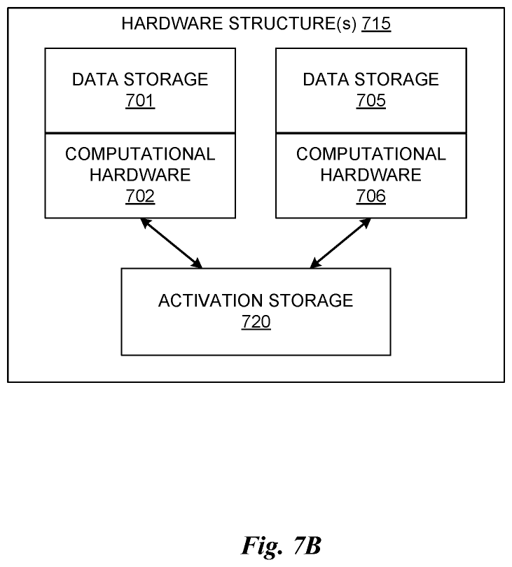

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

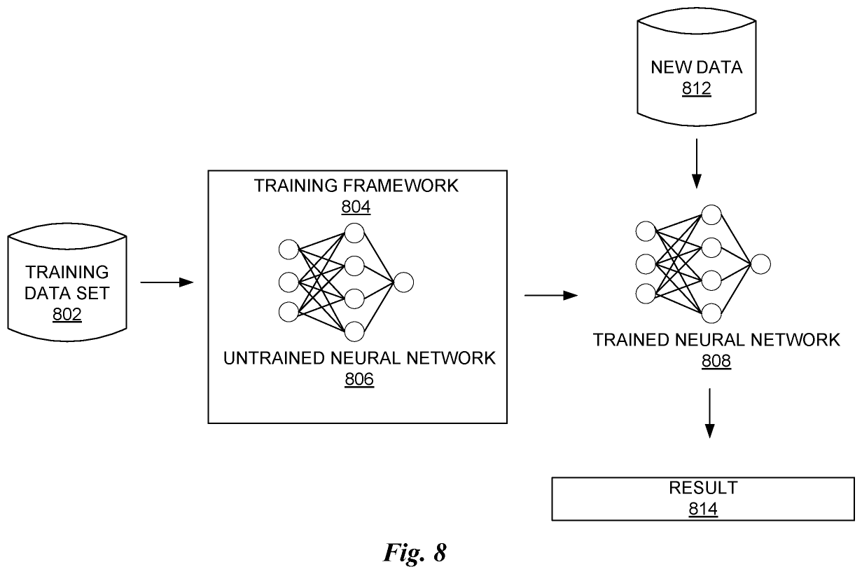

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

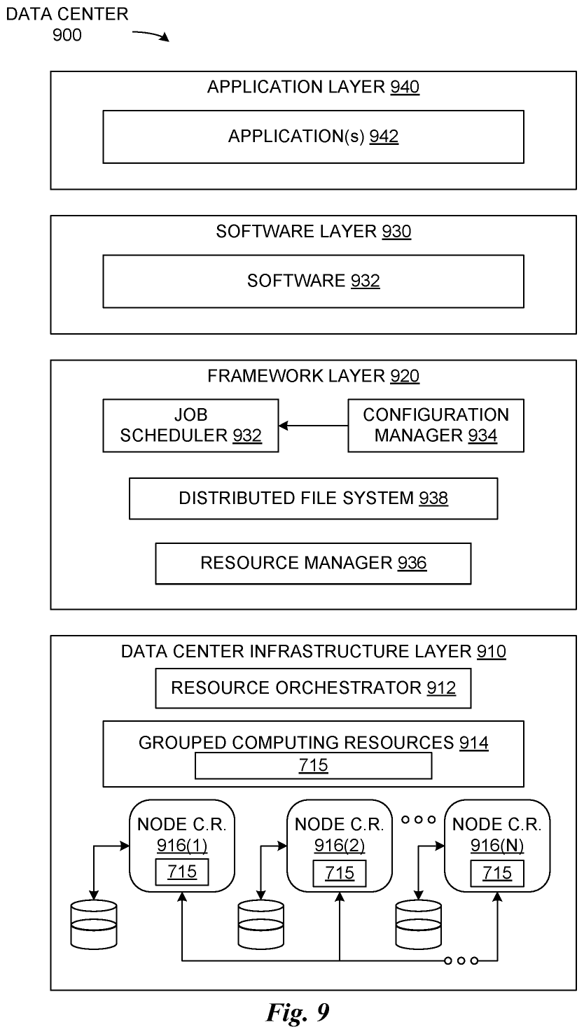

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed to provide for dynamic path selection for processing through a multi-layer neural network. In accordance with FIGS. 1-6, embodiments may provide neural networks usable for performing inferencing operations and for providing inferenced data. The neural networks may be stored (partially or wholly) in one or both of data storage 701 and 705 in inference and/or training logic 715 as depicted in FIGS. 7A and 7B. Training and deployment of the neural networks may be performed as depicted in FIG. 8 and described herein. Distribution of the neural networks may be performed using one or more servers in a data center 900 as depicted in FIG. 9 and described herein.

What is claimed is:

1. A method, comprising:
at a device:
processing an input, through a plurality of layers of a neural network, to predict a data value for the input,
wherein at least one of the plurality of layers of the neural network is partitioned, and wherein a partition of at least one partitioned layer is dynamically selected for the processing according to the input; and
outputting the data value.

2. The method of claim 1, wherein the input includes a coordinate position.

3. The method of claim 2, wherein the input further includes at least one additional parameter value.

4. The method of claim 1, wherein each partitioned layer of the neural network includes a plurality of partitions.

5. The method of claim 4, wherein each partitioned layer of the neural network includes at least two partitions with a different set of weights.

6. The method of claim 5, wherein each set of weights is arranged as a matrix.

7. The method of claim 5, wherein each partitioned layer of the neural network has a different number of weights per partition than other partitioned layers of the neural network.

8. The method of claim 5, wherein, for each partitioned layer of the neural network, the at least two partitions are repeated at a defined frequency.

9. The method of claim 8, wherein the frequency increases for each subsequent partitioned layer of the neural network.

10. The method of claim 8, wherein a layout of the at least two partitions that are repeated within the partitioned layer is predefined.

11. The method of claim 10, wherein the layout includes a random order.

12. The method of claim 10, wherein the layout includes a smooth interpolation across the partitions within the partitioned layer.

13. The method of claim 10, wherein the layout is predefined for a task to be performed using the neural network.

14. The method of claim 13, wherein the task is an image generation task.

15. The method of claim 13, wherein the task is a novel-view synthesis task.

16. The method of claim 13, wherein the task is an image fitting task.

17. The method of claim 13, wherein the task is a video fitting task.

18. The method of claim 9, wherein each partition, per partitioned layer, handles a corresponding range of inputs.

19. The method of claim 5, wherein each partitioned layer of the neural network has a random pattern of partitions.

20. The method of claim 1, wherein, for the at least one partitioned layer of the neural network, only the selected partition is active for processing the input.

21. The method of claim 1, wherein the input is a pixel position, and wherein the data value is a color at the pixel position.

22. The method of claim 1, wherein the input is processed along with a conditional input, through the plurality of layers of the neural network, to predict the data value for the input.

23. The method of claim 22, wherein the conditional input is a vector derived from at least one of a text or an image.

24. The method of claim 1, wherein a partition of each partitioned layer is dynamically selected for the processing according to the input.

25. A system, comprising:
a non-transitory memory storage comprising instructions; and
one or more processors in communication with the memory, wherein the one or more processors execute the instructions to:
process an input, through a plurality of layers of a neural network, to predict a data value for the input,
wherein at least one of the plurality of layers of the neural network is partitioned, and wherein a partition of at least one partitioned layer is dynamically selected for the processing according to the input; and
output the data value.

26. A non-transitory computer-readable media storing computer instructions which when executed by one or more processors of a device cause the device to:
process an input, through a plurality of layers of a neural network, to predict a data value for the input,
wherein at least one of the plurality of layers of the neural network is partitioned, and wherein a partition of at least one partitioned layer is dynamically selected for the processing according to the input; and
output the data value.
